(19) United States
(12) Patent Application Publication
(10) Pub. No.: US 2011/0119369 A1
(43) Pub. Date: May 19, 2011

(54) MONITORING COMPUTER SYSTEM PERFORMANCE

(75) Inventor: PRADIPTA KUMAR BANERJEE, Bangalore (IN)

(73) Assignee: International Business Machines,Corporation, Armonk, NY (US)

(21) Appl. No.: 12/617,935

(22) Filed: Nov. 13, 2009

(51) Int. Cl. G06F 15/173

(52) U.S. Cl. 709/224

(57) ABSTRACT

Disclosed are embodiments related to a method for monitoring performance of a plurality of client nodes. The client nodes are coupled to a master node over a network. The method comprises the master node requesting performance data from at least one of the client nodes. At least one of the client nodes being configured to collect the performance data from at least one other client node and transmit the performance data to the master node. Other embodiments are also disclosed.

### BACKGROUND

Typically, in a computer system, it is often necessary to collect data for purposes of monitoring the systems. For example, a computer server or workstation may need to monitor the temperature of its CPU so as to take appropriate action should the temperature exceed a certain threshold. Again, a web server computer may monitor and record the rate of page hits and initiate an action if the number of page hits exceeds a certain rate.

In larger computer systems it may be necessary to monitor data of a number of computers. For example, in a server farm, a particular server may be required to monitor the CPU temperatures, CPU usage or memory usage for a large number of servers. In another example, a master computer may be required to record the rate of page hits of a large number of web servers. However, in these large systems, system constraints may render it unfeasible to collect data from a central point. In the given example of monitoring web servers, there may not be sufficient bandwidth to relay information to the monitoring computer for every instance of a page hit.

In the given example of monitoring web servers, a web server may be configured to relay only the sum of page hits to the master computer at regular intervals, thereby reducing the amount of bandwidth required. However, the cost of transmitting information from a number of inputs is directly proportional to the number of inputs. In the given example of monitoring web servers, should there be 1000 web servers, 1000 data connections and transmissions would have to be made at regular intervals to the monitoring computer. Data connections and transmissions consume resources such as memory, processing power and bandwidth in a manner proportional to the number of computers to monitor and negatively impacts upon scalability. Without a method and system to effectively monitor such computer systems the promise of this technology may never be fully achieved.

### SUMMARY

According to a first embodiment of the invention, there is provided a method for monitoring performance of a plurality of client nodes. The client nodes are coupled to a master node over a network. The method comprises the master node requesting performance data from at least one of the client nodes. At least one of the client nodes being configured to collect the performance data from at least one other client node and transmit the performance data to the master node.

According to a further embodiment of the invention there is provided a computer system for monitoring performance of a plurality of client nodes. The client nodes are coupled to a master node over a network. The system comprises a master node including a processor, memory device, and a network interface and one or more client nodes including a processor, memory device, and a network interface. The processor of the master node is configured to request performance data from at least one of the client nodes. The processor of at least one of the client nodes being configured to collect the performance data from at least one other client node and transmit the performance data to the master node.

According to yet a further embodiment of the invention there is provided a computer program product for monitoring performance of a plurality of client nodes. The client nodes are coupled to a master node over a network. The computer program product comprises a computer usable medium having computer usable program code. The computer usable program code comprises computer usable program code configured to cause the master node to request performance data from at least one of the client nodes, cause at least one of the client nodes to collect the performance data from at least one of at least one other client node and transmit the performance data to the master node.

According to a further embodiment of the invention there is provided a computer program product for monitoring performance of a plurality of client nodes. The client node is coupled to a master node over a network. The computer program product comprises: a computer readable medium, program instructions to request performance data from at least one of the client nodes, program instructions to collect the performance data from at least one of at least one other client node at least one of the client nodes, and program instructions to transmit the performance data to the master node. The program instructions are stored on the computer readable media. Several other exemplary embodiment of the invention are also disclosed.

### BRIEF DESCRIPTION OF THE DRAWINGS

Embodiments of the invention will best be understood by reference to the following detailed description of an illustrative embodiment when read in conjunction with the accompanying drawings, wherein like reference numerals indicate like components, and in the drawings:

FIG. 1 shows an exemplary embodiment of a system for monitoring inputs;

FIG. 2 shows an exemplary embodiment of a system for monitoring nodes with reduced cost;

FIG. 3A shows a schematic block diagram of an exemplary embodiment of a general purpose computer system on which the invention may be practiced;

FIG. 3B shows a schematic block diagram of an exemplary embodiment of a general purpose computer system on which the invention may be practiced; and

FIG. 4 shows an exemplary embodiment of a method for monitoring nodes with reduced cost.

### DETAILED DESCRIPTION

Where reference is made in any one or more of the accompanying drawings to steps and/or features, which have the same reference numerals, those steps and/or features have for the purposes of this description the same function(s) or operation(s), unless the contrary intention appears.

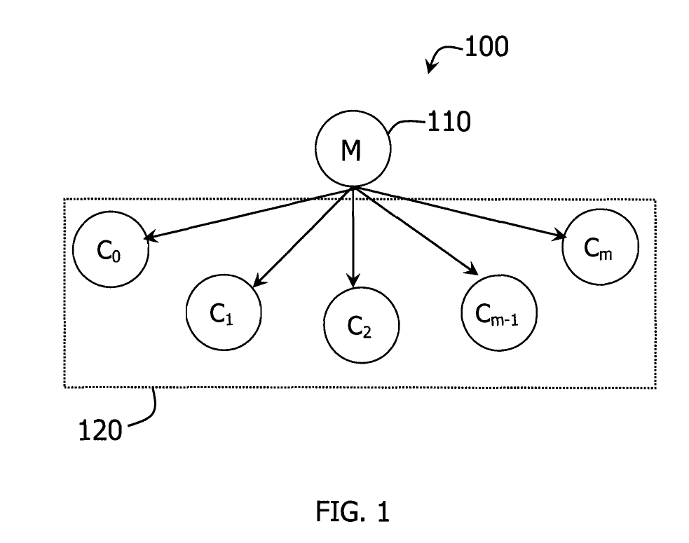

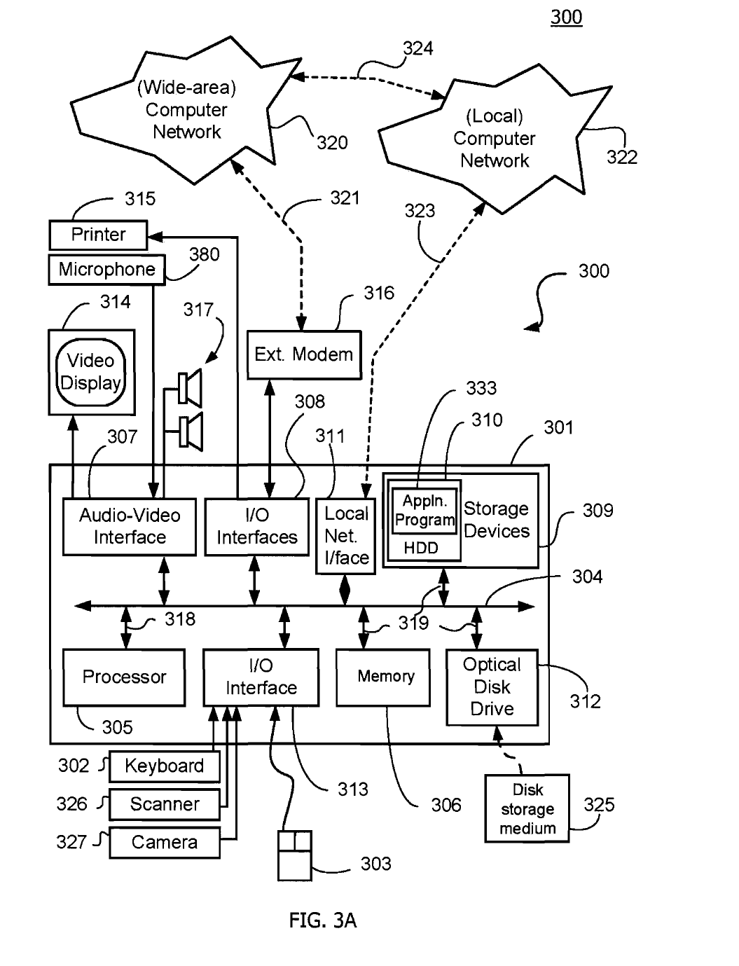

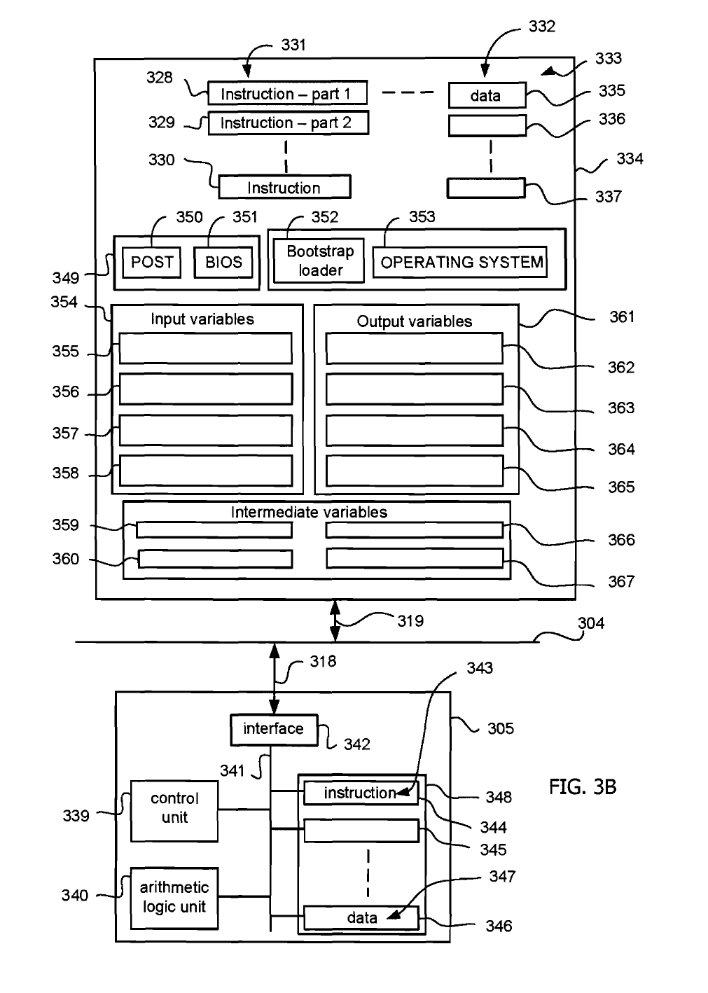

FIG. 1 shows an exemplary embodiment of a system 100 for monitoring m inputs (hereafter referred to as nodes) using m requests. The system 100 consists of a master node (M) 110 and one or more client nodes (Cᵢ) 120, where T is an integer, preferably greater than one. Master node 100 may be implemented as one or more software application programs executable within the computer hardware arrangements (for example a computer system, but not limiting as will be appreciated by one skilled in the art. Any arrangement having at least a processor and a memory but be advantageously used as a computer system), as illustrated in FIGS. 3A and 3B, which has been described below. Similarly, any of client nodes 120 may be implemented as one or more software application programs executable within the computer hardware arrangements as illustrated in FIGS. 3A and 3B, which has been described below in detail. In the example of monitoring computer system resources, each client node 120 may be a physically separate computer or alternatively, one or more software applications operating on one or more computers. Similarly, the master node 110 may be a physically separate computer or alternatively, a software application running on one or more computers.

In system 100 there is typically a single master node 110 and one or more client nodes 120. As such, in the example of monitoring CPU temperatures in a server farm, each client node C₀-Cₘ 120 would be assigned a task of monitoring and recording data associated with the temperature of a particular CPU. In order to collect the CPU temperature information, the master node 110 would request data from each client node 120 in turn. The master node 110 may request data from each client node 120 by routing a request to the address of each client node 120. The address of a client node 120 for example may be an IP address or any other form of resource locator and the request may comply with the TCP/IP protocol. In this manner, the master node 110 may, for example, be assigned the task of monitoring client nodes 120 with IP addresses in the range 192.168.1.1-192.168.1.5. As such, the master node 110 would address each client node 120 in turn as 192.168.1.1 corresponding to C₀, 192.168.1.2 corresponding to C₁, 192.168.1.3 corresponding to C₂ and so forth.

The data collected by the client nodes, may be any data related relevant to monitoring purposes. This data collected may be selected from the set of variables consisting of: CPU temperature, physical memory usage, kernel physical memory usage, commit charge, number of handles, number of threads, number of processes, page file usage, CPU usage, network usage and other system performance metrics, and not limiting to the above.

In the manner given above, the cost associated with collecting information across client nodes 120 is directly proportional to the number of client nodes 120. While this may be feasible for a small number of client nodes 120, it may become unfeasible for a large number of client nodes 120.

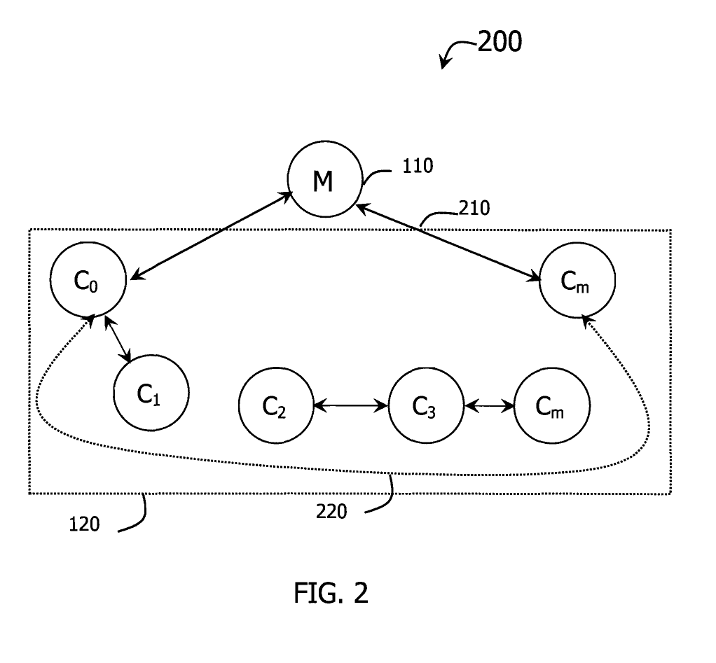

FIG. 2 shows an exemplary embodiment of system 200 for monitoring m nodes requiring less than m requests. System 200 consists of a master node 110 and one or more client nodes 120. In system 200, the client nodes 120 are configured with the additional ability to not only monitor and collect their own data, but also to request and collect data of their adjacent client nodes. For example, client node C₀ may be configured to monitor and collect data related to the temperature of its CPU and also collect the CPU temperature of client nodes C₁ and Cₘ. In FIG. 2, the master node 110 requests 210 are represented in solid lines and the client nodes 120 requests 220 are represented in broken lines. If an IP addressing scheme is used, node C₀, for example with an IP address of 192.168.1.2, may be configured to monitor the adjacent IP addresses 192.168.1.1 and 192.168.1.3. Therefore, the master node 110 need only make one request 210 to node C₀ to gather data related to nodes C₀, Cᵢ and Cₘ.

A client node 120 may be configured to perform requests periodically. Alternatively, a client node 120 may be configured to perform a request in response to a request from the master node. In this manner, for example, a master node 110 may request monitoring data from a client node C₀. Client node C₀ then performs a request to client nodes C₁ and C_{M} to receive the monitoring data from client nodes C₁ and C_{M}. Client C₀ may then aggregate the data it received from client nodes C₁ and C_{M} and its own monitoring data and transmit the aggregated data to the master node 110.

Client nodes 120 may be configures to perform requests using Microsoft™ .Net Remoting™. In particular, in the system of 200, client nodes C₁ and Cₘ may operate an instance of Microsoft Internet Information Systems (IIS™) to host a remotable object. Client node C₀ may be configured to call a function of the remotable object at periodic intervals to retrieve the relevant data from client nodes C₁ and Cₘ. For example, the remotable object of client nodes C₁ and Cₘ may be implemented using Microsoft C#™ using the source code shown in Table 1 below. The web.config file is not shown in this instance but should be configured accordingly.

TABLE 1
Remotable object source code

```
using System;
using System.Runtime.Remoting;
using System.Runtime.Remoting.Channels;
using System.Threading;
using System.Web;
public interface ICPUService{
  float GetCPUTemp ( );
}
public class CPUServiceClass : MarshalByRefObject, ICPUService {
  public ServiceClass( ){
    InstanceHash = this.GetHashCode( );
  }
  public float GetCPUTemp( ){
    return this.CPUMonitor.m_fCPUTemp;
  }
}
```

Furthermore, client node Cₒ may be configured to request the relevant data from client nodes C₁ using the code shown in Table 2 below.

TABLE 2
Requesting data using the remotable object

```
using System;
using System.Collections;
using System.Diagnostics;
using System.Net;
using System.Reflection;
using System.Runtime.Remoting;
using System.Runtime.Remoting.Channels;
using System.Security.Principal;
public class CPUMonitor{
  private float m_remoteCPUTemp;
  public void RequestCPUTemp( ){
    RemotingConfiguration.Configure(“Client.exe.config”);
    ServiceClass service = new ServiceClass( );
    this.m_remoteCPUTemp = service.GetCPUTemp( );
  }
}
```

In this example, client node Cₒ is configured using Client.exe.config shown in Table 3 to address client node C₁ at resource locator http://localhost:80/HttpBinary/SAService.rem.

TABLE 3
Web config file for client node Cₒ

```
<configuration>
  <system.runtime.remoting>
    <application>
      <channels>
        <channel ref=“http” useDefaultCredentials=“true” port=“0”>
          <clientProviders>
            <formatter
              ref=“binary”
            />
          </clientProviders>
        </channel>
      </channels>
      <client>
        <wellknown
          url=“http://localhost:80/HttpBinary/SAService.rem”
          type=“ServiceClass, ServiceClass”
        />
      </client>
    </application>
  </system.runtime.remoting>
</configuration>
```

In the manner described above, system 200 reduces the number of requests required by the master node by three. Mathematically, the cost K of the requests performed by the master node is directly proportional to the ceiling of the number of client nodes m divided by three:

K□□m/3□ 1

It will be apparent to one skilled in the art that client nodes 120 in system 200 could be configured to monitor more than two client nodes to even further reduce the number of requests performed by the master node.

FIGS. 3A and 3B collectively form an exemplary embodiment of a schematic block diagram of a general purpose computer system 300, upon which the various arrangements/embodiments of the invention described can be practiced. In this manner, nodes 110, 120 may be implemented one or more software application programs executable within the computer system 300 as described below.

As seen in FIG. 3A, the computer system 300 is formed by a computer module 301, input devices such as a keyboard 302, a mouse pointer device 303, a scanner 326, a camera 327, and a microphone 380, and output devices including a printer 315, a display device 314 and loudspeakers 317. An external Modulator-Demodulator (Modem) transceiver device 316 may be used by the computer module 301 for communicating to and from a communications network 320 via a connection 321. The network 320 may be a wide-area network (WAN), such as the Internet or a private WAN. Where the connection 321 is a telephone line, the modem 316 may be a traditional “dial-up” modem. Alternatively, where the connection 321 is a high capacity (for example a cable) connection, the modem 316 may be a broadband modem. A wireless modem may also be used for wireless connection to the network 320.

The computer module 301 typically includes at least one processor unit 305, and a memory unit 306 for example formed from semiconductor random access memory (RAM) and semiconductor read only memory (ROM). The module 301 also includes an number of input/output (I/O) interfaces including an audio-video interface 307 that couples to the video display 314, loudspeakers 317 and microphone 380, an I/O interface 313 for the keyboard 302, mouse 303, scanner 326, camera 327 and optionally a joystick (not illustrated), and an interface 308 for the external modem 316 and printer 315.

In some implementations, the modem 316 may be incorporated within the computer module 301, for example within the interface 308. The computer module 301 also has a local network interface 311 which, via a connection 323, permits coupling of the computer system 300 to a local computer network 322, known as a Local Area Network (LAN). As also illustrated, the local network 322 may also couple to the wide network 320 via a connection 324, which would typically include a so-called “firewall” device or device of similar functionality. The interface 311 may be formed by an Ethernet™ circuit card, a Bluetooth™ wireless arrangement or an IEEE 802.11 wireless arrangement.

The interfaces 308 and 313 may afford either or both of serial and parallel connectivity, the former typically being implemented according to the Universal Serial Bus (USB) standards and having corresponding USB connectors (not illustrated). Storage devices 309 are provided and typically include a hard disk drive (HDD) 310. Other storage devices such as a floppy disk drive and a magnetic tape drive (not illustrated) may also be used. An optical disk drive 312 is typically provided to act as a non-volatile source of data. Portable memory devices, such optical disks (for example—CD-ROM, DVD), USB-RAM, and floppy disks for example may then be used as appropriate sources of data to the system 300.

The components 305 to 313 of the computer module 301 typically communicate via an interconnected bus 304 and in a manner which results in a conventional mode of operation of the computer system 300 known to those in the relevant art. Examples of computers on which the described arrangements can be practiced include Personal Computers and compatibles systems, including portable electronic devices such as PDAs, mobile phones and the likes, Sun Sparcstations™, Apple Mac™ or like computer systems.

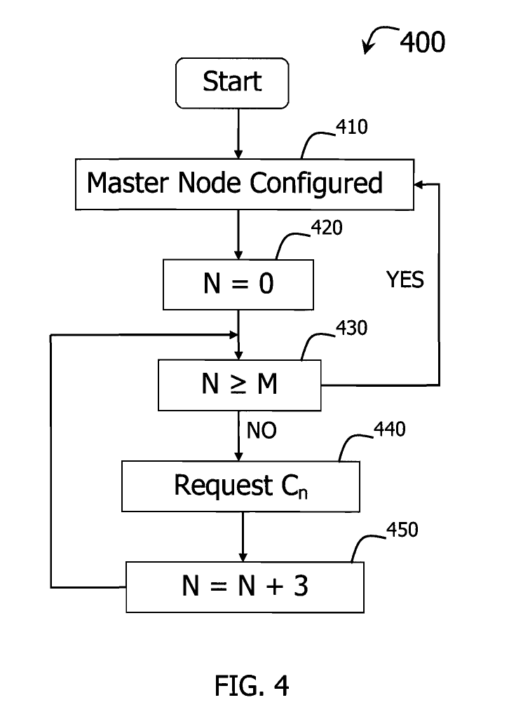

The method of monitoring client nodes may be implemented using the computer system 300 wherein the processes of FIG. 4, to be described, may be implemented as one or more software application programs 333 executable within the computer system 300. In particular, the steps of the method of a master node monitoring a set of client nodes are effected by instructions 331 in the software 333 that are carried out within the computer system 300. The software instructions 331 may be formed as one or more code modules, each for performing one or more particular tasks. The software may also be divided into two separate parts, in which a first part and the corresponding code modules performs the monitoring and a second part and the corresponding code modules manage a user interface between the first part and the user.

The software 333 is generally loaded into the computer system 300 from a computer readable medium, and is then typically stored in the HDD 310, as illustrated in FIG. 3A, or the memory 306, after which the software 333 can be executed by the computer system 300. In some instances, the application programs 333 may be supplied to the user encoded on one or more CD-ROM 325 and read via the corresponding drive 312 prior to storage in the memory 310 or 306.

Alternatively the software 333 may be read by the computer system 300 from the networks 320 or 322 or loaded into the computer system 300 from other computer readable media. Computer readable storage media refers to any storage medium that participates in providing instructions and/or data to the computer system 300 for execution and/or processing. Examples of such storage media include floppy disks, magnetic tape, CD-ROM, a hard disk drive, a ROM or integrated circuit, USB memory, a magneto-optical disk, or a computer readable card such as a PCMCIA card and the like, whether or not such devices are internal or external of the computer module 301. Examples of computer readable transmission media that may also participate in the provision of software, application programs, instructions and/or data to the computer module 301 include radio or infra-red transmission channels as well as a network connection to another computer or networked device, and the Internet or Intranets including e-mail transmissions and information recorded on Websites and the like.

The second part of the application programs 333 and the corresponding code modules mentioned above may be executed to implement one or more graphical user interfaces (GUIs) to be rendered or otherwise represented upon the display 314. Through manipulation of typically the keyboard 302 and the mouse 303, a user of the computer system 300 and the application may manipulate the interface in a functionally adaptable manner to provide controlling commands and/or input to the applications associated with the GUI(s). Other forms of functionally adaptable user interfaces may also be implemented, such as an audio interface utilizing speech prompts output via the loudspeakers 317 and user voice commands input via the microphone 380.

FIG. 3B is a detailed schematic block diagram of the processor 305 and a “memory” 334. The memory 334 represents a logical aggregation of all the memory devices (including the HDD 310 and semiconductor memory 306) that can be accessed by the computer module 301 in FIG. 3A.

When the computer module 301 is initially powered up, a power-on self-test (POST) program 350 executes. The POST program 350 is typically stored in a ROM 349 of the semiconductor memory 306. A program permanently stored in a hardware device such as the ROM 349 is sometimes referred to as firmware. The POST program 350 examines hardware within the computer module 301 to ensure proper functioning, and typically checks the processor 305, the memory (309, 306), and a basic input-output systems software (BIOS) module 351, also typically stored in the ROM 349, for correct operation. Once the POST program 350 has run successfully, the BIOS 351 activates the hard disk drive 310. Activation of the hard disk drive 310 causes a bootstrap loader program 352 that is resident on the hard disk drive 310 to execute via the processor 305.

This loads an operating system 353 into the RAM memory 306 upon which the operating system 353 commences operation. The operating system 353 is a system level application, executable by the processor 305, to fulfill various high level functions, including processor management, memory management, device management, storage management, software application interface, and generic user interface.

The operating system 353 manages the memory (309, 306) in order to ensure that each process or application running on the computer module 301 has sufficient memory in which to execute without colliding with memory allocated to another process. Furthermore, the different types of memory available in the system 300 must be used properly so that each process can run effectively. Accordingly, the aggregated memory 334 is not intended to illustrate how particular segments of memory are allocated (unless otherwise stated), but rather to provide a general view of the memory accessible by the computer system 300 and how such is used.

The processor 305 includes a number of functional modules including a control unit 339, an arithmetic logic unit (ALU) 340, and a local or internal memory 348, sometimes called a cache memory. The cache memory 348 typically includes a number of storage registers 344-346 in a register section. One or more internal buses 341 functionally interconnect these functional modules. The processor 305 typically also has one or more interfaces 342 for communicating with external devices via the system bus 304, using a connection 318.

The application program 333 includes a sequence of instructions 331 that may include conditional branch and loop instructions. The program 333 may also include data 332 which is used in execution of the program 333. The instructions 331 and the data 332 are stored in memory locations 328-330 and 335-337 respectively. Depending upon the relative size of the instructions 331 and the memory locations 328-330, a particular instruction may be stored in a single memory location as depicted by the instruction shown in the memory location 330. Alternately, an instruction may be segmented into a number of parts each of which is stored in a separate memory location, as depicted by the instruction segments shown in the memory locations 328-329.

In general, the processor 305 is given a set of instructions which are executed therein. The processor 305 then waits for a subsequent input, to which it reacts to by executing another set of instructions. Each input may be provided from one or more of a number of sources, including data generated by one or more of the input devices 302, 303, data received from an external source across one of the networks 320, 322, data retrieved from one of the storage devices 306, 309 or data retrieved from a storage medium 325 inserted into the corresponding reader 312. The execution of a set of the instructions may in some cases result in output of data. Execution may also involve storing data or variables to the memory 334.

The disclosed monitoring arrangements use input variables 354, which are stored in the memory 334 in corresponding memory locations 355-358. The monitoring arrangements produce output variables 361, which are stored in the memory 334 in corresponding memory locations 362-365. Intermediate variables may be stored in memory locations 359, 360, 366 and 367.

The register section 344-346, the arithmetic logic unit (ALU) 340, and the control unit 339 of the processor 305 work together to perform sequences of micro-operations needed to perform “fetch, decode, and execute” cycles for every instruction in the instruction set making up the program 333. Each fetch, decode, and execute cycle comprises:

(a) a fetch operation, which fetches or reads an instruction 331 from a memory location 328;

(b) a decode operation in which the control unit 339 determines which instruction has been fetched; and

(c) an execute operation in which the control unit 339 and/or the ALU 340 execute the instruction.

Thereafter, a further fetch, decode, and execute cycle for the next instruction may be executed. Similarly, a store cycle may be performed by which the control unit 339 stores or writes a value to a memory location 332.

Each step or sub-process in the processes of FIG. 4 is associated with one or more segments of the program 333, and is performed by the register section 344-347, the ALU 340, and the control unit 339 in the processor 305 working together to perform the fetch, decode, and execute cycles for every instruction in the instruction set for the noted segments of the program 333.

FIG. 4 shows a method 400 for implementing the system 200 for monitoring m nodes. The method 400 begins at step 410 when the master node 110 is configured via the I/O interface 131. Specifically, the IP address range of the client nodes 120 to monitor may be input into the master node 100. For example, the master node 110 may be configured to monitor client nodes in the IP address range 192.168.1.1 to 192.168.1.5. The master node configuration is stored in the memory device 306. At step 420 application code executed in the processor 305 sets an internal counter n to 0. The internal counter n may be an intermediate variable stored in memory locations 359, 360, 366 and 367. At decision 430, the processor 305 determines if the internal counter n is greater or equal than the number of client nodes m. If n is greater or equal to the number of nodes m, the processor 305 resets n to 0 at step 420.

The method 400 otherwise continues at step 440 where the master node 110 performs a request to client node Cₙ. At step 440, the processor may be configured to take into account boundary conditions. For instance, where n=0, processor 305 may be configured to perform a request on Cₘ and C₁. Similarly, where n=m, processor 305 may be configured to perform a request on Cₘ₋₁ and C₀. If client node Cₙ is a remote computer, the request is routed via the network interfaces 308 or 311. At step 450, the processor 305 increments n by 3 and the process repeats.

Alternatively, at step 450, the processor 305 may increment n in accordance with the number of client nodes 120 that a particular client node Cₙ is configured to monitor. For example, if each client node Cₙ where configured to monitor only 1 other client node, processor 305 would increment n by 2. Alternatively, if each client node Cₙ were configured to monitor three other client nodes, processor 305 would increment n by 4.

The foregoing describes only some embodiments of the invention, and modifications and/or changes can be made thereto without departing from the scope and spirit of the embodiments of the invention, and the embodiments being illustrative and not restrictive

As will be readily apparent to a person skilled in the art, embodiments of the invention can be realized in hardware, software, or a combination of hardware and software. Any kind of computer/server system(s)—or other apparatus adapted for carrying out the methods described herein—is suited. A typical combination of hardware and software could be a general-purpose computer system with a computer program that, when loaded and executed, carries out the respective methods described herein. Alternatively, a specific use computer, containing specialized hardware for carrying out one or more of the functional tasks of the invention, could be utilized.

Aspects of the invention, can also be embodied in a computer program product, which comprises all the respective features enabling the implementation of the methods described herein, and which—when loaded in a computer system—is able to carry out these methods. Computer program, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The terminology used herein is for the purpose of describing particular embodiments only and is not intended to be limiting of the invention. As used herein, the singular forms “a”, “an” and “the” are intended to include the plural forms as well, unless the context clearly indicates otherwise. The corresponding structures, features, materials, acts, and equivalents of all means or step plus function elements in the claims below are intended to include any structure, material, or act for performing the function in combination with other claimed elements as specifically claimed. The disclosure has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method for monitoring performance of a plurality of client nodes, the client nodes being coupled to a master node over a network, the method comprising: the master node requesting performance data from at least one of the client nodes; and at least one of the client nodes being configured to collect the performance data from at least one other client node and transmit the requested performance data to the master node.

2. The method of claim 1, wherein performance data comprises at least one of a CPU temperature, a physical memory usage, a kernel physical memory usage, a commit charge, number of handles, number of threads, number of processes, a page file usage, a CPU usage and a network usage.

3. The method of claim 1, wherein the nodes represent at least one of computers and software applications.

4. The method of claim 1, wherein the client node is configured to periodically request the performance data from at least one other client node in the network.

5. The method of claim 1, wherein the client node is configured to request the performance data from at least one other client node in response to the request from the master node.

6. The method of claim 1, wherein each node is assigned a unique address.

7. The method of claim 6, wherein the address is a Internet Protocol address.

8. The method of claim 1, wherein at least one of the client node is configured to collect the performance data from two other client nodes.

9. The method of claim 1, wherein the master node is configured to request performance data from every third node of the plurality of client nodes.

10. A computer system for monitoring performance of a plurality of client nodes, the client nodes being coupled to a master node over a network, the system comprising: a master node including a processor, memory device, and a network interface; and one or more client nodes including a processor, memory device, and a network interface; and wherein the processor of the master node being configured to request performance data from at least one of the client nodes; and the processor of at least one client node being configured to collect performance data from at least one other client node and transmit the requested performance data to the master node.

11. The computer system of claim 10, wherein performance data comprises at least one of a CPU temperature, a physical memory usage, a kernel physical memory usage, a commit charge, number of handles, number of threads, number of processes, a page file usage, a CPU usage and a network usage.

12. The computer system of claim 11, wherein the nodes are computers.

13. The computer system of claim 11, wherein at least one client processor is configured to periodically request performance data from at least one other client node at predetermined intervals.

14. The computer system of claim 11, wherein at least one client processor is configured to request the performance data from at least one other client node in response to receiving the request from the master node.

15. The computer system of claim 11, wherein the node network interfaces are assigned unique address, wherein the address is an Internet Protocol address.

16. The computer system of claim 11, wherein the processor of at least one client node is configured to collect performance data from two other client nodes.

17. The computer system of claim 11, wherein the master node is configured to request performance data from every third node of the plurality of client nodes.

18. A storage medium tangibly embodying a program of machine-readable instructions executable by a computer system to carry out a method for monitoring performance of a plurality of client nodes, the client nodes being coupled to a master node over a network wherein the program causes the master node to request performance data from at least one of the client nodes; and causes at least one of the client nodes to collect the performance data from at least one other client node and transmit the performance data to the master node.

19. The method of claim 1, wherein performance data comprises at least one of a CPU temperature, a physical memory usage, a kernel physical memory usage, a commit charge, number of handles, number of threads, number of processes, a page file usage, a CPU usage and a network usage.

20. The method of claim 1, wherein the nodes represent at least one of computers and software applications, and the client node is configured to periodically request the performance data from at least one other client node in the network, and wherein data from at least one other client node in response to the request from the master node.
